(19) United States
(12) Patent Application Publication
(10) Pub. No.: US 2009/0146600 A1
(43) Pub. Date: Jun. 11, 2009

(54) INTELLIGENT FOOT OF HUMANOID ROBOT

(75) Inventors: Gab-Soon KIM, Jinju-si (KR); Jungwon Yoon, Sacheon-si (KR)

Correspondence Address: OBLON, SPIVAK, MCCLELLAND MAIER & NEUSTADT, P.C., 1940 DUKE STREET, ALEXANDRIA, VA, 22314, US

(73) Assignee: IND.-ACAD. COOPER. FOUN. GYEONGSANG NAT. UNIV., Jinju-si (KR)

(21) Appl. No.: 12/026,875

(22) Filed: Feb. 6, 2008

(30) Foreign Application Priority Data
Dec. 11, 2007 (KR) 10-2007-0128390

(51) Int. Cl. B25J 17/00; B25J 19/02; B25J 5/00

(52) U.S. Cl. 318/568.12; 318/568.16; 74/490.03

(57) ABSTRACT

An intelligent foot of a humanoid robot, which enables the robot to safely walk in balance even on the irregular ground, is disclosed. The walking robot's foot includes a backpart unit with a leg which is rotatably installed at the center thereof, and a forepart unit which is rotatably connected to the front of the backpart unit by a foot part connector, wherein 6-axis force/moment sensors are installed on the bottom of the backpart unit and the bottom of the forepart unit, respectively. Further, walking robot's foot includes a backpart unit with a leg which is rotatably installed at the center thereof, and at least two toes which are rotatably connected to the front of the backpart unit by foot part connectors, wherein a 6-axis force/moment sensor is installed on the bottom of the backpart unit, and short shaft sensors are installed on the bottom of the toes.

### BACKGROUND OF THE INVENTION

1. Field of the Invention

The present invention relates to an intelligent foot of a humanoid robot walking while standing up straight, and more particularly to an intelligent foot of a humanoid robot, which enables the robot to safely walk in balance even on the irregular ground, by measuring tri-directional force and tri-directional moment of a forepart and a backpart that are sequentially applied to the backpart and the forepart when the robot walks on the irregular ground as well as the level ground, and then by laterally rotating a backpart unit and a forepart unit.

Also, the present invention relates to an intelligent foot of a humanoid robot having toes installed instead of a forepart, which enables the robot to safely walk in balance even on the irregular ground, by measuring force and moment of a backpart and two toes that are sequentially applied to the backpart and two toes when the robot walks, and then by laterally rotating a backpart unit for contact with the ground and vertically operating the right toe and left toe for contact with the ground.

2. Description of the Related Art

Various robots including an industrial robot are being developed along with the development of technology. Among those robots, there is a robot which can walk while standing up straight (hereinafter, referred to as a ‘humanoid robot’).

Since the humanoid robot has legs, it can walk like a human on the level ground, but it cannot walk naturally like a human on the ground in various shapes such as the irregular ground.

As examples of a foot of the humanoid robot, there are Korean Patent Registration No. 10-0499143, entitled “Ground reaction force detection module for walking robot and robot foot structure adopting the same” and Korean Patent Registration No. 10-0695652, entitled “Apparatus for input sensing of foot of walking robot using ball joints.”

Conventionally, in order for the robot's foot to generate natural walking patterns, pressure sensors are attached to the robot's foot to measure the ZMP (Zero Moment Point) track of the foot and a pattern modeling and control machine is developed using the ZMP track.

However, when the pressure sensors are disposed on the robot's foot, although safe walking patterns are generated on the level ground, the robot can neither walk nor stand up on the irregular ground.

A robot's foot is manufactured with a six-axis force sensor with parallel support mechanism, a single platform and the like by Nishiwaki, etc. in order that the robot can sustain an impact force equal to several times its weight during walking (A Six-axis Force Sensor with Parallel Support Mechanism to Measure the Ground Reaction Force of Humanoid Robot, IEEE International Conference on Robotics and Automation, pp. 2277-2282, 2002). Further, there is a robot's foot with a six-axis force/moment sensor and an impact mitigation device which are coupled to a single platform.

The technology is embodied in Korean Patent Registration No. 10-0571829, entitled “Structure, foot structure and robot employing the same” and Korean Patent Registration No. 10-0654759, entitled “Reduction of motor payload and improvement of stability for biped walking robot using a functional structure of toe.”

As for the problems of the conventional humanoid robot' foot, the robot' foot using pressure sensors has a disadvantage that it is possible to measure the ground reaction only on the level ground since only limited force information is obtained. The foot designed with a six-axis force sensor and a single platform has a disadvantage that safe walking is impossible on the irregular ground even though it can be applied to the level ground, the inclined ground and the like since it cannot mechanically deal with the irregular ground unlike the human foot.

In addition, a conventional system, wherein a robot's foot is divided into a forepart and a backpart that are connected by a foot joint to generate a natural walking track, has a disadvantage that it is difficult to obtain space force information of force and moment to determine the irregular ground.

### SUMMARY OF THE INVENTION

Therefore, the present invention has been made in view of the above problems, and it is an object of the present invention to provide an intelligent foot of a humanoid robot, which enables the robot to safely walk in balance even on the irregular ground, by measuring tri-directional force Fx, Fy and Fz and tri-directional moment Mx, My and Mz of a forepart and a backpart that are sequentially applied to the backpart and the forepart when the robot walks on the irregular ground as well as the level ground, and then by laterally rotating a backpart unit and a forepart unit.

Further, it is another object of the present invention to provide an intelligent foot of a humanoid robot having toes installed instead of a forepart, which enables the robot to safely walk in balance even on the irregular ground, by measuring tri-directional force and moment of a backpart and uni-directional force of two toes that are sequentially applied to the backpart and two toes when the robot walks, and then by laterally rotating a backpart unit for contact with the ground and vertically operating two toes for contact with the ground.

In accordance with an aspect of the present invention, there is provided a walking robot's foot comprising: a backpart unit with a leg which is rotatably installed at the center thereof; and a forepart unit which is rotatably connected to the front of the backpart unit by a foot part connector, wherein 6-axis force/moment sensors are installed on the bottom of the backpart unit and the bottom of the forepart unit, respectively.

In accordance with another aspect of the present invention, there is provided a walking robot's foot comprising: a backpart unit with a leg which is rotatably installed at the center thereof; and at least two toes which are rotatably connected to the front of the backpart unit by foot part connectors, wherein a 6-axis force/moment sensor is installed on the bottom of the backpart unit, and short shaft sensors are installed on the bottom of the toes.

According to the present invention, there is an effect of enabling the robot to safely walk in balance even on the irregular ground, by installing 6-axis force/moment sensors on a backpart and a forepart, respectively, by measuring tri-directional force Fx, Fy and Fz and tri-directional moment Mx, My and Mz of the forepart and the backpart that are sequentially applied to the backpart and the forepart when the robot walks on the irregular ground as well as the level ground, and then by laterally rotating a backpart unit and a forepart unit.

In another example of the foot having two toes, there is an effect of enabling the robot to safely walk in balance even on the irregular ground, by measuring tri-directional force and moment of a backpart and uni-directional (vertical directional) force of two toes that are sequentially applied to the backpart and two toes when the robot walks, and then by laterally rotating a backpart unit for contact with the ground and vertically operating two toes for contact with the ground.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a perspective view showing an example of a leg of a humanoid robot including an intelligent foot according to the present invention;

FIG. 2 illustrates a side view of the leg of the humanoid robot including the intelligent foot shown in FIG. 1;

FIG. 3 illustrates a plan view showing an example of the intelligent foot according to the present invention;

FIG. 4 illustrates a partial cross-sectional side view of the leg of the humanoid robot including the intelligent foot shown in FIG. 1;

FIG. 5 illustrates a cross-sectional view taken along a line A-A of FIG. 4;

FIG. 6 illustrates an exploded perspective view of a musculoskeletal frame installed at the leg of the humanoid robot including the intelligent foot according to the present invention;

FIG. 7 illustrates a cutaway side view showing a portion of the musculoskeletal frame shown in FIG. 6;

FIG. 8 illustrates a cutaway front view showing a portion of the musculoskeletal frame shown in FIG. 6;

FIG. 9 illustrates a cutaway perspective view showing a portion of a rotatable joint of the musculoskeletal frame shown in FIG. 6;

FIG. 10 illustrates a partial cross-sectional side view showing another example of a leg of a humanoid robot including an intelligent foot according to the present invention; and

FIG. 11 illustrates a plan view of the intelligent foot shown in FIG. 10.

### DETAILED DESCRIPTION OF THE PREFERRED EMBODIMENTS

Hereinafter, the present invention will be described in detail with reference to the accompanying drawings.

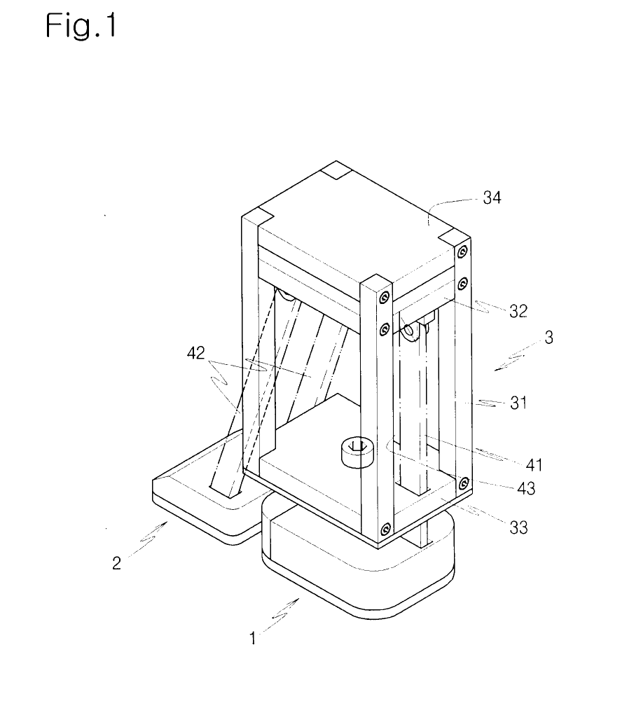

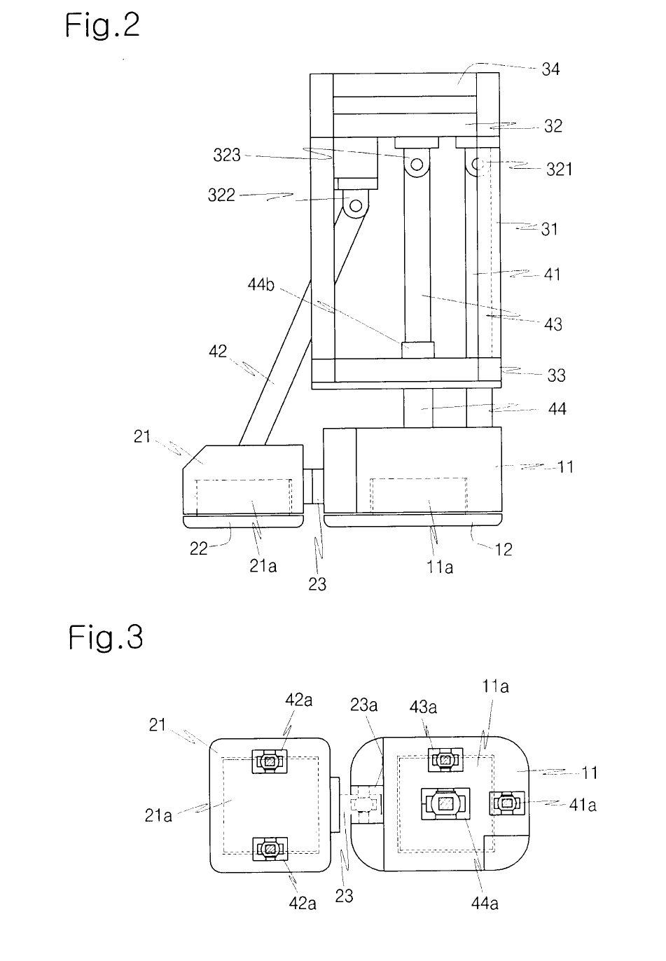

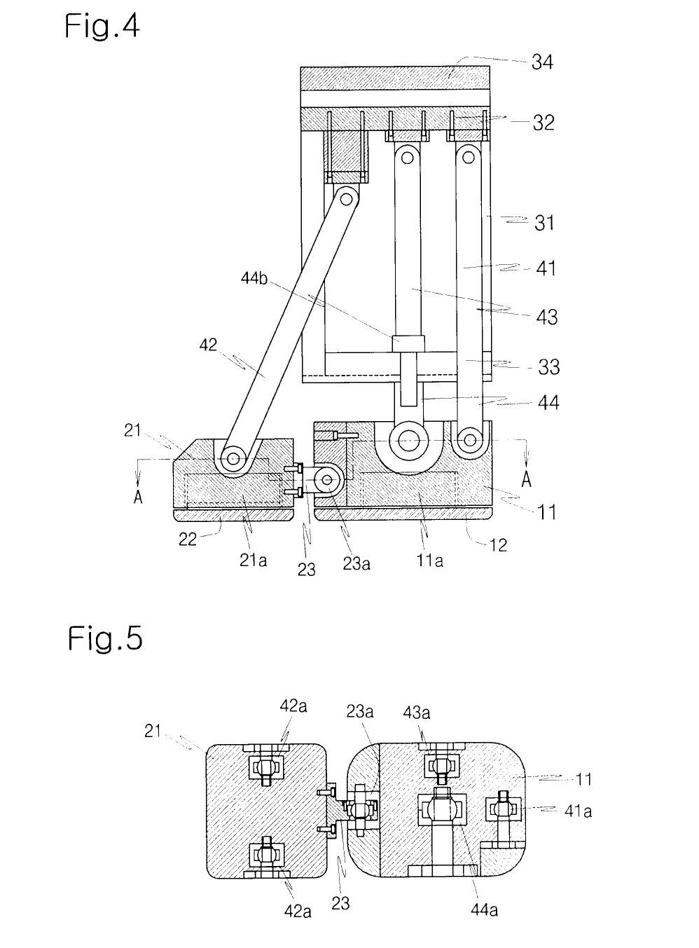

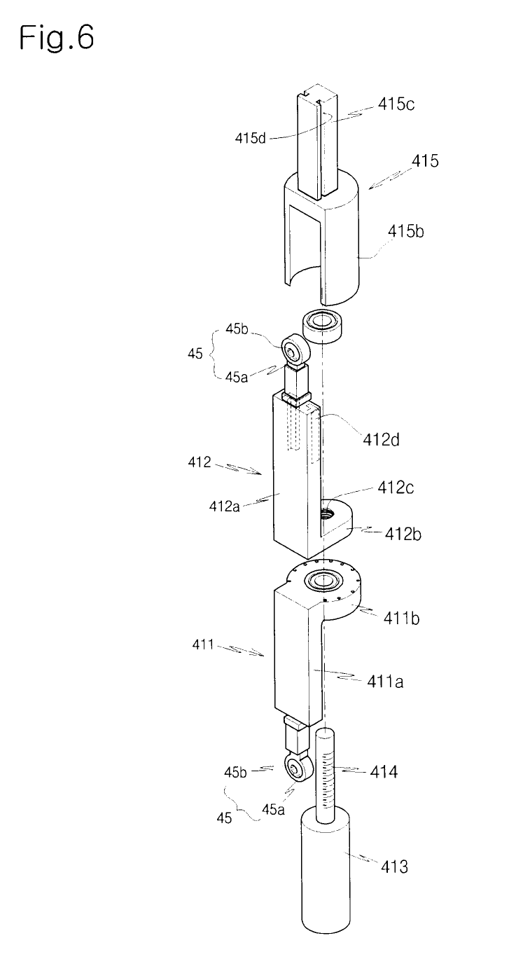

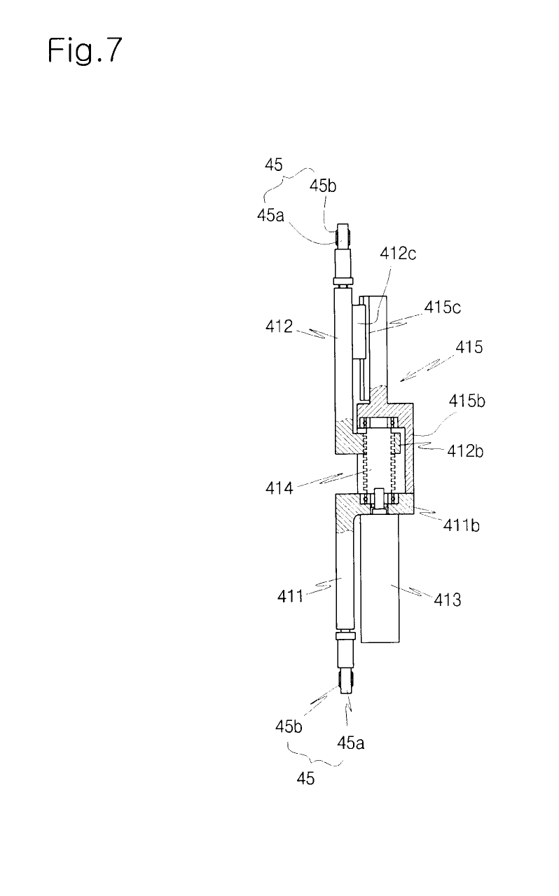

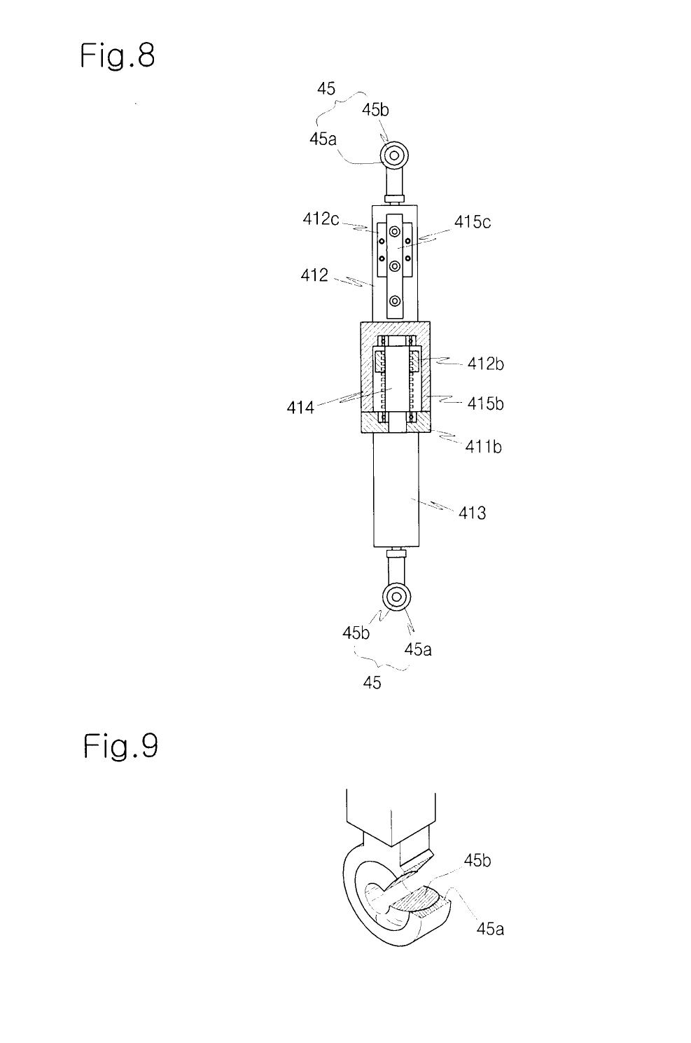

FIG. 1 illustrates a perspective view showing an example of a leg of a humanoid robot including an intelligent foot according to the present invention. FIG. 2 illustrates a side view of the leg of the humanoid robot including the intelligent foot shown in FIG. 1. FIG. 3 illustrates a plan view showing an example of the intelligent foot according to the present invention. FIG. 4 illustrates a partial cross-sectional side view of the leg of the humanoid robot including the intelligent foot shown in FIG. 1. FIG. 5 illustrates a cross-sectional view taken along a line A-A of FIG. 4. FIG. 6 illustrates an exploded perspective view of a musculoskeletal frame installed at the leg of the humanoid robot including the intelligent foot according to the present invention. FIG. 7 illustrates a cutaway side view showing a portion of the musculoskeletal frame shown in FIG. 6. FIG. 8 illustrates a cutaway front view showing a portion of the musculoskeletal frame shown in FIG. 6. FIG. 9 illustrates a cutaway perspective view showing a portion of a rotatable joint of the musculoskeletal frame shown in FIG. 6.

As shown in the drawings, the robot's foot according to the present invention includes a forepart unit 2 and a backpart unit 1, which have 6-axis force/moment sensors 21a and 11a, respectively.

The robot's foot according to the present invention includes the backpart unit 1 with a leg 3 which is rotatably installed at a central portion of the backpart unit 1, and the forepart unit 2 which is rotatably connected to the front of the backpart unit 1 by a foot part connector 23. The 6-axis force/moment sensors 11a and 21a are installed on the bottom of the backpart unit 1 and the bottom of the forepart unit 2, respectively.

As shown FIGS. 2 to 5, the backpart unit 1 and the forepart unit 2 are connected to each other by the foot part connector 23. As shown in the drawings, the foot part connector 23 is immovably coupled to the forepart unit 2 and is rotatably coupled to the backpart unit 1 by a rotatable joint 45.

That is, an end portion of the foot part connector 23, which is connected to the forepart unit 2, is a plate-shaped member that is formed as one body with the foot part connector 23. The plate-shaped member is fixed to the forepart unit 2 by bolts. The other end portion of the foot part connector 23 has the rotatable joint 45, which is fixed to the inside of a connecting groove 23a formed on a backpart body 11 of the backpart unit 1 by a fixing pin or fixing bolt such that the forepart unit and the backpart unit can laterally and vertically rotate with respect to each other.

The leg 3 is connected to the backpart unit 1 and the forepart unit 2. There is provided a leg connecting rod 44 with one end portion which is rotatably connected to the center of the backpart body 11 of the backpart unit 1 by the rotatable joint 45. The leg 3 includes a lower plate 33 which is fixed to the other end portion of the leg connecting rod 44, an upper plate 32 which is installed above the lower plate 33 to be spaced from the lower plate 33, and a number of skeletal frames 31 which are installed at the edges of the upper and lower plates 32 and 33 to connect the upper and lower plates 32 and 33.

The structure for connecting the leg 3 to the backpart unit 1 and the forepart unit 2 such that the backpart unit 1 and the forepart unit 2 can rotate as shown in the drawings will be explained below.

First, as for the configuration of the backpart unit 1 and the forepart unit 2, the backpart unit 1 has the 6-axis force/moment sensor 11a installed at a groove formed on the bottom surface of the backpart unit 1. The backpart unit 1 includes the backpart body 11 with a number of connecting grooves 23a, 41a, 43a and 44a formed on its upper surface to insert and install rotatable joints 45 therein, and a bottom plate 12 which is installed on the bottom surface of the backpart body 11 to protect the 6-axis force/moment sensor 11a. The forepart unit 2 has the 6-axis force/moment sensor 21a installed at a groove formed on the bottom surface of the forepart unit 2. The forepart unit 2 includes a forepart body 21 with a number of connecting grooves 42a formed on its upper surface, and a bottom plate 22 which is installed on the bottom surface of the forepart body 21 to protect the 6-axis force/moment sensor 21a.

In order to rotatably connect the above-configured backpart unit 1 and forepart unit 2 to the leg 3, a number of hinge connectors 321, 322 and 323 are further installed on the bottom surface of the upper plate 32 of the leg 3.

As a means for rotatably connecting the leg 3 with the backpart unit 1 and the forepart unit 2, there are provided musculoskeletal frames 41, 42 and 43 installed between the connecting grooves 23a, 41a, 42a, 43a and 44a formed on the forepart body 21 and the backpart body 11 and the hinge connectors 321, 322 and 323 installed on the upper plate 32.

The musculoskeletal frames 41, 42 and 43 have a variable length so as to adjust the inclination of the backpart unit 1 and the forepart unit 2.

As shown in FIGS. 6 to 8, each of the musculoskeletal frames 41, 42 and 43 includes a lower musculoskeletal frame 411 and an upper musculoskeletal frame 412.

The lower musculoskeletal frame 411 includes the rotatable joint 45 installed at a lower end thereof, which is inserted into the connecting groove 23a, 41a, 42a, 43a or 44a to rotate in the forward-backward and left-right directions, and a bent portion 411b disposed at an upper end thereof, which is bent toward one side while being perpendicular to a main portion 411a. The upper musculoskeletal frame 412 includes an upper end which is rotatably connected to the hinge connector 321, 322 or 323 in the forward-backward direction and a bent portion 412b disposed at a lower end thereof, which is bent perpendicularly to a main portion 412a and has a screw shaft hole 412c.

The above-configured lower and upper musculoskeletal frames 411 and 412 can be extended from each other to adjust a total length, thereby rotating the backpart unit 1 and the forepart unit 2. As a means for adjusting the length of the lower and upper musculoskeletal frames 411 and 412, there are provided a motor 413 and a screw shaft 414.

The motor 413 has a rotation shaft installed to pass through a shaft hole formed on the bent portion 412b of the lower musculoskeletal frame 411. The screw shaft 414 is connected to the rotation shaft of the motor 413 and is installed to engage with a spiral groove formed on the screw shaft hole 412c formed on the bent portion 412b of the upper musculoskeletal frame 412. When the screw shaft 414 is rotated by driving the motor 413, a screw groove of the screw shaft hole 412c formed on the upper musculoskeletal frame 412 moves vertically to adjust the total length of the lower and upper musculoskeletal frames 411 and 412.

In the musculoskeletal frame 41, 42 or 43, a guide member 415 is further installed on the surface of the bent portion 411b of the lower musculoskeletal frame 411 facing the upper musculoskeletal frame 412. The guide member 415 includes a connecting cylindrical body 415b which is fixed to the upper surface of the bent portion 411b of the lower musculoskeletal frame 411, and a guide rod 415c which extends from an upper end of the connecting cylindrical body 415b and has guide grooves 415d in a longitudinal direction. Further, as represented by a dotted line in FIG. 6, guide plates 412d having projections engaging with the guide grooves 415d are installed on the surface of the main portion 412a of the upper musculoskeletal frame 412 facing the guide rod 415c.

The guide member 415 is provided to uniformly maintain a length adjusting direction of the lower and upper musculoskeletal frames 411 and 412.

Although the musculoskeletal frames 41, 42 and 43 have different lengths, since the musculoskeletal frames 41, 42 and 43 generally having the same configuration may be used, the description of the other frames is omitted.

In the robot's foot, lower ends of the musculoskeletal frames 41, 42 and 43 and a lower end of the leg connecting rod 44 should be connected to the backpart unit 1 and the forepart unit 2 so as to rotate in the forward-backward and left-right directions as shown in the drawings. The rotatable joints 45 are provided to rotatably connect the lower ends with the backpart and forepart units 1 and 2.

The rotatable joints 45 are connected to the opposite ends of the musculoskeletal frames 41, 42 and 43, respectively. Each rotatable joint 45 includes a rotation supporter 45a having a circular groove formed at the center thereof and a fixing ball 45b which is rotatably installed at the circular groove formed at the rotation supporter 45a and has a hole into which a fixing pin is inserted.

The rotatable joint 45 is fixed to the corresponding connecting groove of the backpart unit or the forepart unit by passing a fixing pin or bolt through the hole of the fixing ball 45b and fastening the fixing pin or bolt. The rotation supporter 45a, which is installed to cover the outside of the fixing ball 45b, can rotate in the forward-backward and left-right directions with respect to the fixing ball 45b, thereby rotating the musculoskeletal frames 41, 42 and 43 and the leg connecting rod 44.

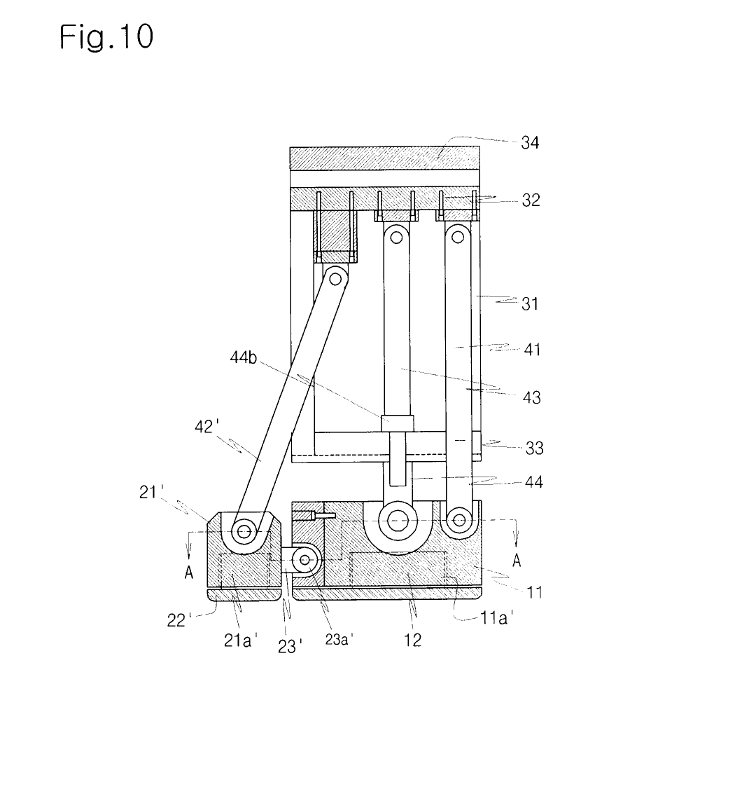

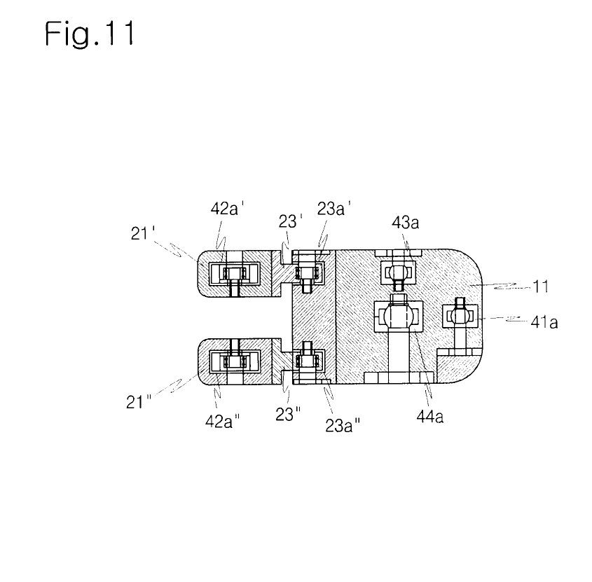

As shown in FIGS. 10 and 11, another foot structure according to the present invention is configured by connecting toes 2′ and 2″ instead of the forepart.

The robot's foot having the toes 2′ and 2″ includes the backpart unit 1 with the leg 3 which is rotatably installed at the central portion of the backpart unit 1, and at least two toes 2′ and 2″ which are rotatably connected to the front of the backpart unit 1 by foot part connectors 23′ and 23″. The 6-axis force/moment sensor 11a is installed on the bottom of the backpart unit 1, and short shaft sensors 21a′ and 21a″ are installed on the bottom of the toes 2′ and 2″.

That is, at least two toes 2′ and 2″ are provided differently from the above-described robot's foot including the forepart and the short shaft sensors 21a′ and 21a″ are provided at the toes 2′ and 2″ instead of the forepart unit. The short shaft sensors serve to detect only a pressure applied in a vertical direction and may be configured as a load cell.

The load cell may employ a commonly-used one that is very small-sized.

Of course, the 6-axis force/moment sensors may be used instead of the short shaft sensors 21a′ and 21a″.

The other components of the robot's foot including the toes are similar to those of the above-described robot's foot. Thus, the detailed description thereof is omitted.

However, since the reference numerals and terms are changed, the toes 2′ and 2″ are described again. The short shaft sensors 21a′ and 21a″ are installed at grooves formed on the bottom surfaces of the toes 2′ and 2″. The toes 2′ and 2″ include toe bodies 21′ and 21″ with a number of connecting grooves 42a′ and 42a″ formed on their upper surfaces, and bottom plates 22′ and 22″ which are installed on the bottom surfaces of the toe bodies 21′ and 21″ to protect the short shaft sensors 21a′ and 21a″. A number of hinge connectors 321, 322 and 323 are further installed on the bottom surface of the upper plate 32 of the leg 3. The musculoskeletal frames 41, 42 and 43 having a variable length so as to adjust the inclination of the backpart unit 1 and the toes 2′ and 2″ are connected between the connecting grooves 23a, 41a, 43a, 44a, 42a′ and 42a″ formed on the backpart body 11 and the toe bodies 21′ and 21″ and the hinge connectors 321, 322 and 323 installed on the upper plate 32.

However, in this configuration, the toe bodies 21′ and 21″ correspond to the forepart body 21, and the bottom plates 22′ and 22″ correspond to the bottom plate 22. The connecting grooves 42a′ and 42a″ correspond to the connecting grooves 42a.

As described above and shown in the drawings, the toes 2′ and 2″ have a smaller width than that of the forepart unit 2, and the short shaft sensors 21a′ and 21a′ are installed therein. The short shaft sensors 21a′ and 21a″ may be replaced by the 6-axis force/moment sensors.

The above-described 6-axis force/moment sensor is installed in the robot or mechanical equipment and may be configured as one selected among sensors for simultaneously measuring tri-directional force and tri-directional moment. Since the 6-axis force/moment sensor is well known, the detailed description thereof is omitted.

Further, the 6-axis force/moment sensor may employ a technology developed and patented by the present applicant.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A walking robot's foot comprising:
a backpart unit with a leg which is rotatably installed at the center thereof; and
a forepart unit which is rotatably connected to the front of the backpart unit by a foot part connector,
wherein 6-axis force/moment sensors are installed on the bottom of the backpart unit and the bottom of the forepart unit, respectively.

2. The walking robot's foot according to claim 1, wherein the leg includes:
a lower plate which is fixed to one end portion of a leg connecting rod with the other end portion which is rotatably connected to the center of a backpart body of the backpart unit by a rotatable joint;
an upper plate which is installed above the lower plate to be spaced from the lower plate; and
a number of skeletal frames which are installed at edges of the upper and lower plates to connect the upper and lower plates.

3. The walking robot's foot according to claim 2, wherein the backpart unit includes the 6-axis force/moment sensor installed at a groove formed on a bottom surface thereof; the backpart body with a number of connecting grooves formed on its upper surface to insert and install rotatable joints therein; and a bottom plate which is installed on a bottom surface of the backpart body to protect the 6-axis force/moment sensor,
the forepart unit includes the 6-axis force/moment sensor installed at a groove formed on a bottom surface thereof; a forepart body with a number of connecting grooves formed on its upper surface; and a bottom plate which is installed on a bottom surface of the forepart body to protect the 6-axis force/moment sensor,
a number of hinge connectors are further installed on a bottom surface of the upper plate of the leg, and
musculoskeletal frames having a variable length to adjust inclinations of the backpart and forepart units are connected between the connecting grooves formed on the forepart and backpart bodies and the hinge connectors installed on the upper plate.

4. The walking robot's foot according to claim 3, wherein each of the musculoskeletal frames includes:
a lower musculoskeletal frame having the rotatable joint installed at a lower end thereof, which is inserted into the connecting groove to rotate in forward-backward and left-right directions, and a bent portion disposed at an upper end thereof, which is bent toward one side while being perpendicular to a main portion;
an upper musculoskeletal frame having an upper end which is rotatably connected to the hinge connector in the forward-backward direction and a bent portion disposed at a lower end thereof, which is bent perpendicularly to a main portion and has a screw shaft hole;
a motor having a rotation shaft which is installed to pass through a shaft hole formed on the bent portion of the lower musculoskeletal frame; and
a screw shaft which is connected to the rotation shaft of the motor and engages with a spiral groove formed on the screw shaft hole formed on the bent portion of the upper musculoskeletal frame.

5. The walking robot's foot according to claim 4, wherein a guide member is further installed on a surface of the bent portion of the lower musculoskeletal frame facing the upper musculoskeletal frame,
the guide member includes a connecting cylindrical body which is fixed to an upper surface of the bent portion of the lower musculoskeletal frame; and a guide rod which extends from an upper end of the connecting cylindrical body and has guide grooves in a longitudinal direction, and
guide plates having projections engaging with the guide grooves are installed on a surface of the main portion of the upper musculoskeletal frame facing the guide rod.

6. The walking robot's foot according to claim 4, wherein the rotatable joints are connected to the opposite ends of the musculoskeletal frames, respectively, and each of the rotatable joints includes a rotation supporter having a circular groove formed at the center thereof; and a fixing ball which is rotatably installed at the circular groove formed at the rotation supporter and has a hole into which a fixing pin is inserted.

7. A walking robot's foot comprising:
a backpart unit with a leg which is rotatably installed at the center thereof; and
at least two toes and which are rotatably connected to the front of the backpart unit by foot part connectors and,
wherein a 6-axis force/moment sensor is installed on the bottom of the backpart unit, and short shaft sensors are installed on the bottom of the toes.

8. The walking robot's foot according to claim 7, wherein the short shaft sensors are load cells.

9. The walking robot's foot according to claim 7 or 8, wherein the leg includes:
a lower plate which is fixed to one end portion of a leg connecting rod with the other end portion which is rotatably connected to the center of a backpart body of the backpart unit by a rotatable joint;
an upper plate which is installed above the lower plate to be spaced from the lower plate; and
a number of skeletal frames which are installed at edges of the upper and lower plates to connect the upper and lower plates.

10. The walking robot's foot according to claim 9, wherein the backpart unit includes the 6-axis force/moment sensor installed at a groove formed on a bottom surface thereof; the backpart body with a number of connecting grooves formed on its upper surface to insert and install rotatable joints therein; and a bottom plate which is installed on a bottom surface of the backpart body to protect the 6-axis force/moment sensor,
the toes include the short shaft sensors installed at grooves formed on bottom surfaces thereof; toe bodies with a number of connecting grooves formed on their upper surfaces; and bottom plates which are installed on bottom surfaces of the toe bodies to protect the short shaft sensors,
a number of hinge connectors are further installed on a bottom surface of the upper plate of the leg, and
musculoskeletal frames having a variable length to adjust inclinations of the backpart unit and the toes are connected between the connecting grooves formed on the backpart body and the toe bodies and the hinge connectors installed on the upper plate.

11. The walking robot's foot according to claim 10, wherein each of the musculoskeletal frames includes:
a lower musculoskeletal frame having the rotatable joint installed at a lower end thereof, which is inserted into the connecting groove to rotate in forward-backward and left-right directions, and a bent portion disposed at an upper end thereof, which is bent toward one side while being perpendicular to a main portion;
an upper musculoskeletal frame having an upper end which is rotatably connected to the hinge connector in the forward-backward direction and a bent portion disposed at a lower end thereof, which is bent perpendicularly to a main portion and has a screw shaft hole;
a motor having a rotation shaft which is installed to pass through a shaft hole formed on the bent portion of the lower musculoskeletal frame; and
a screw shaft which is connected to the rotation shaft of the motor and engages with a spiral groove formed on the screw shaft hole formed on the bent portion of the upper musculoskeletal frame.

12. The walking robot's foot according to claim 11, wherein a guide member is further installed on a surface of the bent portion of the lower musculoskeletal frame facing the upper musculoskeletal frame,
the guide member includes a connecting cylindrical body which is fixed to an upper surface of the bent portion of the lower musculoskeletal frame; and a guide rod which extends from an upper end of the connecting cylindrical body and has guide grooves in a longitudinal direction, and
guide plates having projections engaging with the guide grooves are installed on a surface of the main portion of the upper musculoskeletal frame facing the guide rod.

13. The walking robot's foot according to claim 11, wherein the rotatable joints are connected to the opposite ends of the musculoskeletal frames, respectively, and each of the rotatable joints includes a rotation supporter having a circular groove formed at the center thereof; and a fixing ball which is rotatably installed at the circular groove formed at the rotation supporter and has a hole into which a fixing pin is inserted.
